(19) United States
(12) Patent Application Publication
(10) Pub. No.: US 2012/0205499 A1
(43) Pub. Date: Aug. 16, 2012

(54) Flexible Hose Drop Securement System and Method

(76) Inventor: Dale Shelton, Pasco, WA (US)

(21) Appl. No.: 13/371,332

(22) Filed: Feb. 10, 2012

Related U.S. Application Data
(60) Provisional application No. 61/441,711, filed on Feb. 11, 2011.

(51) Int. Cl. F16L 3/10; F16L 3/08

(52) U.S. Cl. 248/62; 248/74.1; 248/70

(57) ABSTRACT

A flexible hose drop securement system is provided having a support bracket and a hose retainer. The support bracket is configured to mount to an elevated water supply pipe of an irrigation device adjacent a hose drop coupled at an entrance end with the water supply pipe. The hose retainer is carried by the support bracket and has an engagement surface configured to secure a segment of a flexible hose drop spaced from the entrance end of the hose drop so as to impart an arc in the hose drop. A method for supporting a hose drop is also provided.

### CROSS REFERENCE TO RELATED APPLICATION

This application claims priority to U.S. Provisional Patent Application Ser. No. 61/441,711 which was filed on Feb. 11, 2011, entitled “Apparatus and Method for Elevating Sprinkler of Flexible Hose Drop on Main Water Line”, the entirety of which is incorporated by reference herein.

### TECHNICAL FIELD

The present invention pertains to irrigation systems, moving or static. More particularly, the present invention relates to apparatus and methods for supporting components of a hose drop on an irrigation device during a crop growing cycle.

### BACKGROUND OF THE INVENTION

It is previously known to irrigate crops in large fields using either a center pivot or a linear move irrigation device. Originally, these devices had a spaced-apart array of individual sprinklers provided atop a main water supply line that was elevated above a field. Over time, U-shaped horseshoe adapters were added in order to allow attachment of downwardly extending drops made from rigid water lines to which a sprinkler was affixed at a bottom end. However, for crops that grow to relatively tall heights, such as corn, there existed a need to adjust the height of sprinklers. Furthermore, there exists a need to reduce or eliminate the need for a U-shaped horseshoe adapter.

### SUMMARY OF THE INVENTION

An apparatus and method are provided for raising and lowering sprinklers provided on an irrigation device, such as a center pivot or linear move irrigation device, as well as for supporting sprinklers and flexible hose drops in elevated configurations. An apparatus and method are also provided for securing electrical and control lines, or cables onto spans, or main water lines on an irrigation device while also providing for support of segments of a flexible hose drop. A sprinkler hanger body is provided for selectively supporting individual sprinklers at raised positions above a traditional drop position using a complementary, mating sprinkler support body. A hose retainer is also provided relative to a support bracket for retaining a segment of a hose so as to eliminate the need for a separate U-shaped horseshoe adapter. Furthermore, a method is provided for supporting a sprinkler in a manner that bends a flexible segment of a hose drop so as to eliminate the need for a U-shaped horseshoe adapter, as well as for further supporting a flexible hose drop and sprinkler in an elevated position.

According to one aspect, a flexible hose drop securement system is provided having a support bracket and a hose retainer. The support bracket is configured to mount to an elevated water supply pipe of an irrigation device adjacent a hose drop coupled at an entrance end with the water supply pipe. The hose retainer is carried by the support bracket and has an engagement surface configured to secure a segment of a flexible hose drop spaced from the entrance end of the hose drop so as to impart an arc in the hose drop.

According to another aspect, an apparatus is provided for supporting a flexible hose drop relative to an irrigation device. The apparatus includes a support member and a hose retention member. The support member is configured to be carried by a water supply pipe on an irrigation device proximate a hose drop fluid coupled with the water supply pipe. The hose retention member is carried by the support member and has a contact surface configured to engage and hold a flexible segment of hose on the hose drop spaced from the entrance end of the hose drop so as to invert the hose to impart an arcuate bend in the hose drop.

According to yet another aspect, a method is provided for supporting a hose drop relative to an irrigation device. The method includes: providing a support member and a hose retention member carried on a water supply pipe of an irrigation device proximate a flexible hose drop extending at an inlet end from the water supply pipe; bending the flexible hose drop to form an arc between the hose retention member and the inlet end; and securing a hose segment of the hose drop with the hose retention member onto the support member so as to retain the formed arc in the hose when water is supplied through the hose.

According to even another aspect, a sprinkler elevating apparatus is provided for use on an irrigation device. The sprinkler elevating apparatus includes at least one clamp member having a cavity configured to grip and encircle a main irrigation pipe line and a hanger body carried by the clamp member having an interface surface configured to mate and demate with a sprinkler support body on a flexible hose drop

### BRIEF DESCRIPTION OF THE DRAWINGS

Preferred embodiments of the disclosure are described below with reference to the following accompanying drawings.

FIG. 1 is a partial perspective view of a segment of a main water line for a center pivot irrigation device having a clamp and hanger assembly affixed to the main water line at each location where a flexible hose drop exits the main water line.

FIG. 2 is a perspective view for the clamp and hanger assembly of FIG. 1 shown assembled together.

FIG. 3 is an exploded perspective view of the clamp and hanger assembly of FIGS. 2 and 3.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

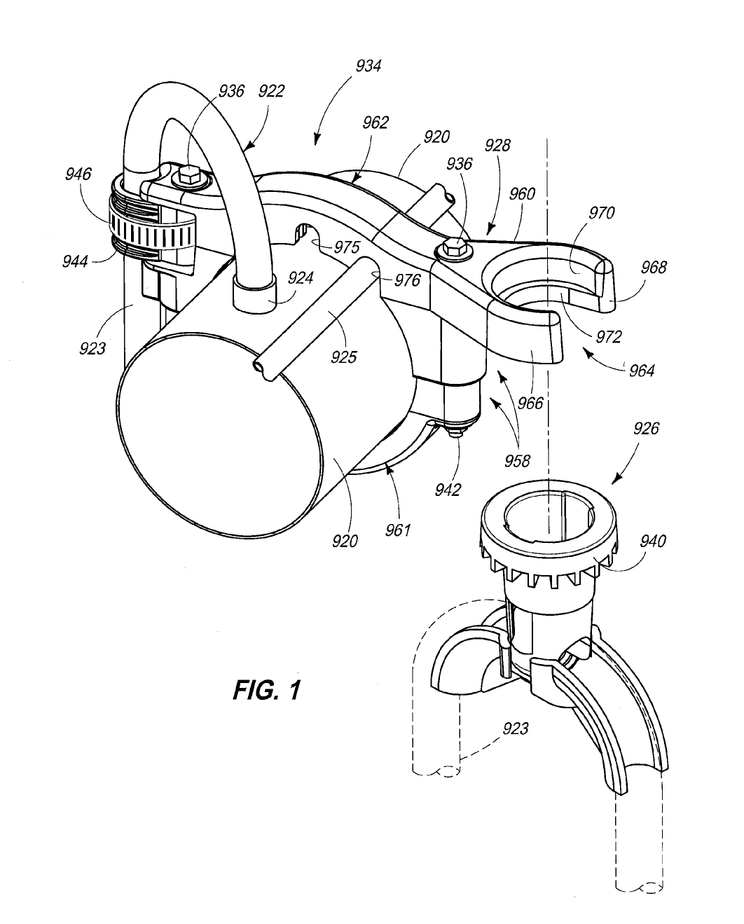

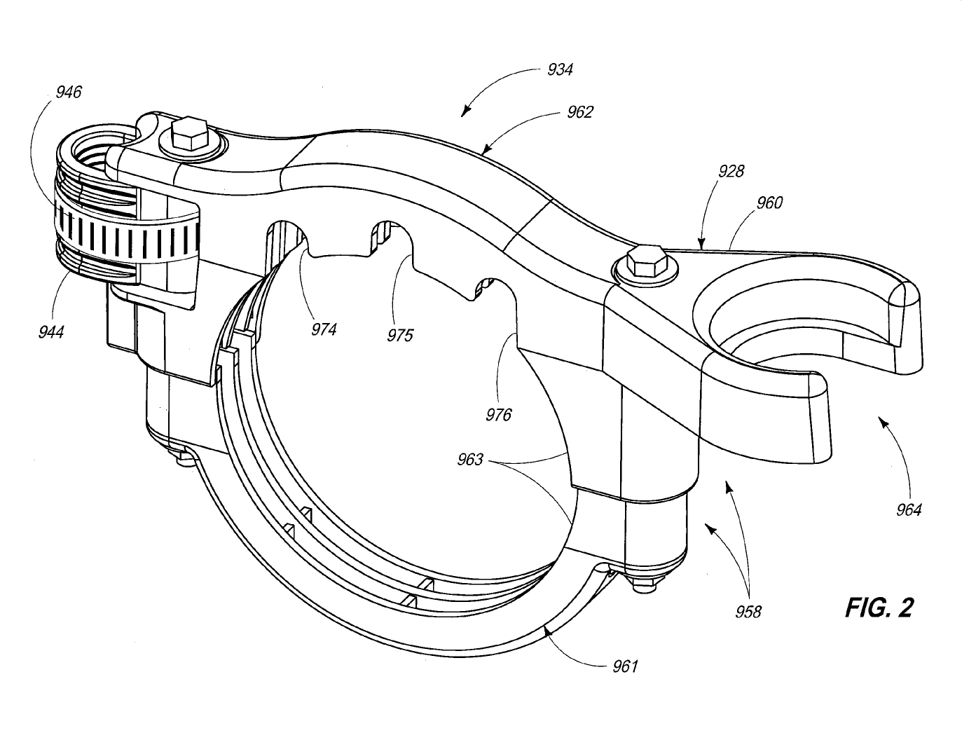

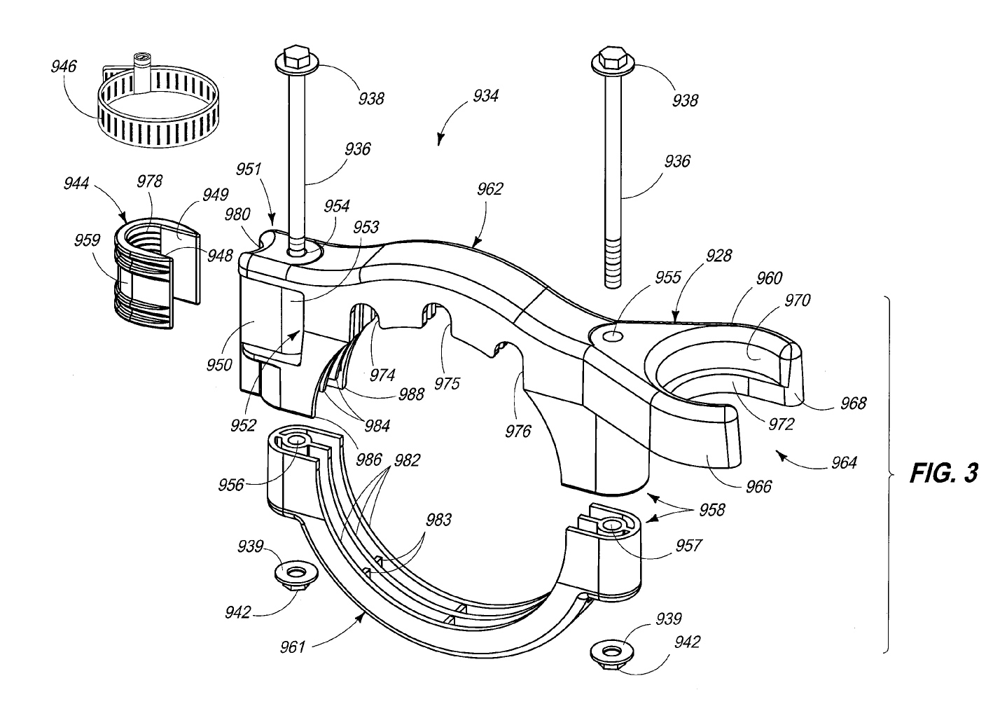

FIG. 1 illustrates a clamp/hanger assembly 934 affixed about a main water line, or pipe 920 of a center pivot irrigation device, according to one embodiment. Clamp/hanger assembly 934 includes a hanger body 928 configured and sized to mate and demate with an outer periphery of a sprinkler support body 926 affixed to a midline (or optionally affixed to a sprinkler component of a flexible hose drop) of a flexible hose 923. An outer contact surface 940 of body 926 mates with a complementary surface 970 to hold a sprinkler (not shown) located at the distal end of the hose drop at an elevated position. Removal of body 926 from hanger body 928 using an elongated, or pole-shaped lifting tool (having a pair of parallel wire engagement fingers) by a person at ground level returns a sprinkler to a lowered position. The same lifting tool is used to raise and load body 926 onto hanger body 928. FIGS. 2-3 further illustrate construction and use of this embodiment. It is understood that the same implementation can be used to raise and lower a sprinker/regulator assembly on a hose drop relative to a linear move irrigation device, or a static irrigation device.

As shown in FIG. 1, a worker can use a mating lifting tool to raise each one of a series of sprinkler/regulator assemblies provided on a downwardly hanging flexible hose drop 923 of a center pivot irrigation device using the lifting tool while the worker remains at ground level. This technique is believed to reduce or eliminate any risk of workers falling off of a center pivot using prior techniques that required a worker to climb atop the center pivot in order to raise each hose drop. During use, the lifting tool mates and demates with a sprinkler support body, or puck 926. Sprinkler support body 926 is mounted to a midline segment of hose 923. Optionally, body 926 can be mounted directly to, or adjacent a sprinkler component. Early in a crop growth cycle, such as for corn crops, hose drop 923 hangs down adjacent the crop. As the crop grows in height, raising the potential of the crop to interrupt water distribution from each sprinkler, the worker raises each sprinkler individually using the lifting tool while the worker remains at ground level. In this manner, the worker avoids the need to climb up a ladder, or climb onto truss rods of a truss on an irrigation device.

As shown in FIG. 1, main water line, or pipe 920 comprises a galvanized steel pipe having a polypropylene lining inside of the steel pipe. According to such construction, a special sealed hose drop fitting 924 extends through an aperture in pipe 920 and connects to an end of flexible hose, or drop 923. With such construction, it is desirable to impart a defined U-shaped bend 922 in hose 923 so as to prevent any unnecessary torque at fitting 924 that might lead to failure of the seal with pipe 920. A yoke, or clamp collar 944 on clamp/hanger assembly 934 induces a U-shaped bend 922 in hose 923, thereby imparting a defined geometry under water pressure to bend 922. By properly spacing apart the position of collar 944 along hose 923 (relative to fitting 924), hose 923 will not kink when placed under a supply of internal water pressure during use. Optionally, it is understood that clamp/hanger assembly 934 can be mounted onto any water line on a linear moving irrigation device or on any form of stationary irrigation devices, such as fixed water supply lines provided in a greenhouse. The formation of bend 922 eliminates the need for a U-shaped horseshoe adapter on water supply pipe 920.

Additionally, clamp/hanger assembly 934 secures a span cable (including power and control lines) 925 along pipe 920 at each discrete location adjacent a flexible hose drop 923 along main line, or pipe 920 of an irrigation device. By securing span cable 925 between each clamp/hanger assembly 934 and an outer surface of pipe 920, risk that someone will steal span cable 925 for resale as scrap metal will be greatly reduced. More particularly, span cable 925 is positioned within one of clamp grooves 974-976 (see FIGS. 2-3).

In order to support a hanger body 928 off of a main water line 920, a cylindrical aperture 963 is provided between mating/demating lower clamp member 961 and upper clamp member 962, as shown in FIG. 2. Hanger body 928 includes an extended arm 960 that terminates in a yoke 964 configured to receive a complementary sprinkler support body 926.

FIG. 1 illustrates lower clamp member 961 and upper clamp member 962 forcibly engaged together about pipe 920 by securing together threaded fasteners, or bolts 936 and threaded nuts 942. Clamp members 961 and 962 cooperate with fasteners 936 and 942 to provide a clamp assembly 958. Optionally, a layer of adhesive friction sandpaper, or non-skid can be provided between clamp assembly and pipe 920 in order to further ensure that clamp assembly 958 does not rotate relative to pipe 920.

As shown in FIG. 1, a cylindrical outer surface 940 of puck 926 is mated and demated with a complementary female contact surface 970 on yoke 964. Puck 926 is seated against surface 970 and atop radially inwardly extending surface, or arcuate shelf 972, and between arms 966 and 968.

According to one construction, lower clamp member 961, upper clamp member 962 (and hanger body 928), and clamp collar 944 are each constructed from injection molded polypropylene. Alternatively, any suitable material can be used to form members 961, 962 and collar 944, such as metal, composite materials, or any other suitable structural material. Furthermore, clamp assembly 958 can be sized to fit a pipe 920 (see FIG. 1) having an outer diameter of 4″, 6⅝″, or 8″. Furthermore, such a pipe can have any conduit cross-sectional shaped or dimension. Optionally, clamp/hanger assembly 934 can be made of one or more pieces of metal and welded onto a metal water supply line.

As shown in FIG. 3, a pair of threaded fasteners, or hex head bolts 936 with washers 938 are received through respective through-bores 954 and 955 in upper clamp member 962 and respective through-bores 956 and 957 in lower clamp member 961. Washers 939 and threaded nuts 942 are received on each of bolts 936. Threaded engagement of bolts 936 and nuts 942 drive together clamp members 961 and 962 about an outer surface of a main water supply line (not shown), thereby securing clamp/hanger assembly 934 from translating or rotating relative to a pipe, or water supply line.

Clamp collar 944 of FIG. 3 has a pair of parallel guide surfaces 948 and 949 that mate in sliding engagement with complementary guide surfaces 950 and 951 on member 962. A flexible hose drop segment is received within clamp collar 944, after which clamp collar 944 is mated with and slid along surfaces 950 and 951. A stainless steel hose clamp 946 is then secured around hose clamp seat 959 and through a slot 952 through member 962, adjacent a semi-cylindrical surface 953. A ribbed clamp surface 978 on clamp collar 944 engages with a hose received therein, and forces such hose into further engagement with a ribbed clamp surface 980 on member 962, as hose clamp 946 is tightened thereabout.

As shown in FIG. 3, lower clamp member 961 is injection molded with longitudinal ribs 982 and lateral ribs 983 in order to save material and weight, while maintaining structural strength. Similarly, upper clamp member 962 is injection molded with longitudinal ribs 984 and lateral ribs (not shown, but similar to ribs 983 on member 961). Upper clamp member 962 also includes side walls 986 and 988 at each end that are wider than respective portions of lower clamp member 961, thereby overlying member 961. As such, member 962 is telescopically received into engagement with member 961, as fasteners 936 drive them together into engagement during assembly.

Optionally, hanger body 928 of FIG. 3 can be removed from an alternative version in order to provide a hose clamp via yoke 944 and a cable clamp via clamp grooves 974-976. Further optionally, one or more of hanger body 928, yoke 944 and clamp grooves 974-976 can be removed so as to leave one or more of the remaining features on assembly 934. For example, assembly 934 can provide a hose clamp or a cable clamp, or both a hose clamp and a cable clamp in one version.

According to an embodiment, a flexible hose drop securement system is provided having a clamp member and a hanger body. The clamp member is configured to mount to a main irrigation pipe line of an irrigation device. The hanger body is carried by the clamp member and has an interface surface configured to mate and demate with a sprinkler support body on a flexible hose drop. In one case, the clamp member grips and encircles the main irrigation pipe line. According to other embodiments, hanger body 928 (see FIG. 1) can be eliminated from assembly 934 so as to provide for a clamp that eliminates any need for a U-shaped horseshoe adapter, yet also provides for securement of one or more span cables 925. Likewise, optionally clamp grooves 974-976 (see FIG. 1) can be eliminated from assembly 934. Further optionally, clamp collar 944 (see FIG. 1) can be provided directly on a main water line so as to eliminate any need for a U-shaped horseshoe adapter.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A flexible hose drop securement system, comprising:
a support bracket configured to mount to an elevated water supply pipe of an irrigation device adjacent a hose drop coupled at an entrance end with the water supply pipe; and
a hose retainer carried by the support bracket having an engagement surface configured to secure a segment of a flexible hose drop spaced from the entrance end of the hose drop so as to impart an arc in the hose drop.

2. The flexible hose drop securement system of claim 1, wherein the hose retainer imparts a U-shaped bend in the hose drop when subjected to internal water pressure.

3. The flexible hose drop securement system of claim 1, wherein the support bracket comprises a pair of clamp members secured together about the water supply pipe.

4. The flexible hose drop securement system of claim 3, wherein the support bracket further comprises a fastener extending between the pair of clamp members configured to draw together the clamp members about the water supply pipe so as to provide a clamp assembly.

5. The flexible hose drop securement system of claim 4, wherein the first clamp member and the second clamp member each comprise a semi-cylindrical engagement surface configured in assembly to encircle and grip a cylindrical water supply pipe.

6. The flexible hose drop securement system of claim 5, wherein one of the first clamp member and the second clamp member comprises a pair of end recesses configured to telescopically receive a respective pair of ends for the other of the first clamp member and the second clamp member.

7. The flexible hose drop securement system of claim 5, wherein the support bracket comprises a groove provided along an inner surface of one of the clamp members configured to retain a span cable along the water supply pipe.

8. The flexible hose drop securement system of claim 1, further comprising a hanger body carried by the support bracket having an interface surface configured to mate and demate with a sprinkler support body on a flexible hose drop to raise and lower the sprinkler support body between elevated and lowered positions.

9. The flexible hose drop securement system of claim 8, wherein the hanger body comprises a yoke having an arcuate interface surface and a shelf.

10. An apparatus for supporting a flexible hose drop relative to an irrigation device, comprising:
a support member configured to be carried by a water supply pipe on an irrigation device proximate a hose drop fluid coupled with the water supply pipe; and
a hose retention member carried by the support member having a contact surface configured to engage and hold a flexible segment of hose on the hose drop spaced from the entrance end of the hose drop so as to invert the hose to impart an arcuate bend in the hose drop.

11. The apparatus of claim 10, wherein the hose retention member imparts a U-shaped bend in the hose drop when subjected to internal water pressure.

12. The apparatus of claim 10, wherein the support member comprises a clamp collar having a contact surface configured to be mated and demated with a complementary portion of the support member to trap the segment of flexible hose therebetween.

13. The apparatus of claim 12, wherein the clamp collar comprises a semi-cylindrical clamp surface communicating with a pair of parallel guide surfaces.

14. The apparatus of claim 13, wherein the support member comprises a pair of parallel guide surfaces complementary to the parallel guide surfaces of the clamp collar and a semi-cylindrical clamp surface communicating with the guide surfaces and extending through the support member.

15. The apparatus of claim 14, where the support member further comprises a hose clamp configured to extend about the clamp collar and the semi-cylindrical clamp surface of the support member to tighten together respective clamp surfaces on the clamp collar and the support member against opposed surfaces of the flexible hose segment.

16. The apparatus of claim 14, wherein the contact surface of the clamp collar and the contact surface of the support member each comprise a ribbed clamp surface.

17. The apparatus of claim 10, further comprising a hanger body depending from the support member and configured to removably support a sprinkler support body on a flexible hose drop at an elevated position.

18. The apparatus of claim 17, wherein the hanger body comprises a yoke having an arcuate contact surface and a radially inwardly extending arcuate support surface.

19. A method for supporting a hose drop relative to an irrigation device, comprising:
providing a support member and a hose retention member carried on a water supply pipe of an irrigation device proximate a flexible hose drop extending at an inlet end from the water supply pipe;
bending the flexible hose drop to form an arc between the hose retention member and the inlet end; and
securing a hose segment of the hose drop with the hose retention member onto the support member so as to retain the formed arc in the hose when water is supplied through the hose.

20. The method of claim 19, wherein the hose retention member is provided on the support member, and the support member is affixed to the water supply pipe.

21. The method of claim 19, further comprising providing a hanger body depending from the support member and configured to removably support a sprinkler support body on a flexible hose drop at an elevated position.

22. The method of claim 18, further comprising removably supporting a sprinkler support body on the hanger body so as to elevate a sprinkler of the flexible hose drop.
